(19) United States
(12) Patent Application Publication
(10) Pub. No.: US 2024/0407586 A1
(43) Pub. Date: Dec. 12, 2024

(54) ERGONOMIC BEVERAGE MACHINE

(71) Applicant: SOCIETE DES PRODUITS NESTLE S.A., Vevey (CH)

(72) Inventors: LAURENT LAGOUCHE, Evian Les Bains (FR); KEVIN REITZ, Lausanne (CH)

(21) Appl. No.: 18/700,594

(22) PCT Filed: Oct. 11, 2022
(86) PCT No.: PCT/EP2022/078212

§ 371 Date: Apr. 11, 2024

(30) Foreign Application Priority Data
Oct. 13, 2021 (EP) 21202356.8

(51) Int. Cl. A47J 31/36; A47J 31/46

(52) U.S. Cl. CPC A47J 31/3633; A47J 31/46

(57) ABSTRACT

A machine (1) for preparing a beverage from an ingredient (2) includes: —a body (10) comprising a fluid line (11, 11a, 11b, 11c, 11d, 11e) extending from a source of liquid to a beverage outlet (11) located at or on a body front face (12) delimiting a front area for locating a beverage collection user-recipient; —a first module (20) that is assemblable to the body (10) and that is disassemblable therefrom by said user; and—a second module (30) different to the first module (20), the second module (30) being assemblable to the body (10) and being disassemblable therefrom by said user. The body (10) has a side face (14) that is different to the front face (12). The side face (12) has: a first assembly arrangement (122) for assembly by the user of the first module (20) to the body (10); and a second assembly arrangement (123) for assembly by the user of the second module (30) to the body (10).

### FIELD OF THE INVENTION

The field of the invention pertains to beverage preparation machines provided with an ergonomic handling by the user, e.g. machines using capsules of an ingredient of the beverage to be prepared.

For the purpose of the present description, a “beverage” is meant to include any human-consumable liquid substance, such as tea, coffee, hot or cold chocolate, milk, soup, baby food, etc. . . . A “capsule” is meant to include any pre-portioned beverage ingredient, such as a flavouring ingredient, within an enclosing packaging of any material, in particular an airtight packaging, e.g. plastic, aluminium, recyclable and/or biodegradable packagings including paper-based packagings, and of any shape and structure, including soft pods or rigid cartridges containing the ingredient. The capsule may contain an amount of ingredient for preparing a single beverage portion or a plurality of beverage portions.

### BACKGROUND ART

Certain beverage preparation machines use capsules containing ingredients to be extracted or to be dissolved and/or ingredients that are stored and dosed automatically in the machine or else are added at the time of preparation of the drink. Some beverage machines possess filling means that include a pump for liquid, usually water, which pumps the liquid from a source of water that is cold or indeed heated through heating means, e.g. a thermoblock or the like.

Especially in the field of coffee preparation, machines have been widely developed in which a capsule containing beverage ingredients is inserted in a brewing device. The brewing device is tightly closed about the capsule, water is injected at the first face of the capsule, the beverage is produced in the closed volume of the capsule and a brewed beverage can be drained from a second face of the capsule and collected into a receptacle such as a cup or glass.

Ingredient mixing modules, e.g. brewing devices have been developed to facilitate insertion of a “fresh” capsule and removal of the capsule upon use. Typically, the brewing devices comprise two parts relatively movable from a configuration for inserting/removing a capsule to a configuration for brewing the ingredient in the capsule. The actuation of the movable part of the brewing device may be manual as disclosed in WO 2009/043630, WO 01/15581, WO 02/43541, WO 2010/015427, WO 2010/128109, WO 2011/144719 and WO 2012/032019. Various handle configurations are disclosed in EP 1867260, WO 2005/004683, WO WO2007/135136, WO 2008/138710, WO 2009/074550, WO 2009/074553, WO 2009/074555, WO 2009/074557, WO 2009/074559, WO 2010/037806, WO 2011/042400, WO 2011/042401 and WO 2011/144720. Integrations of such arrangements into beverage machines are disclosed in WO 2009/074550, WO2011/144719, EP2014195046, EP2014195048 and EP2014195067. The actuation of the movable part of the brewing device may be motorized, as for example disclosed in EP 1 767 129, WO 2012/025258, WO 2012/025259 and WO 2013/127476.

Further systems are disclosed in WO 2008/148601, WO 2013/007776, WO 2013/007779 and WO 2013/007780.

A beverage machine typically includes a housing containing a beverage processing module and a water tank in fluid communication with the beverage processing module. Examples of such beverage machines are disclosed in EP 1 208 782, EP 1 267 687, EP 1 686 879, EP 1 731 065, EP 1 829 469, EP 1 864 598, EP 1 865 815, EP 1 867 260, EP 1 878 368, EP 2 222 210, EP 2 222 211, EP 2 222 212, EP 2 227 121, EP 2 227 122, US 2008/0006159, U.S. Pat. No. 7,165,488, WO 2007/111884, WO 2009/074553, WO 2010/015427, WO 2011/089210 and WO 2012/055767. Usually the water tank is removable to be refilled by a user when empty. Some systems include a continuous water supply by connecting the beverage machine to the city water distribution network, as for instance disclosed in CN 201076369, WO 2016/005348, WO 2016/005349, WO 2016/005350 and WO 2016/005351.

### SUMMARY OF THE INVENTION

The invention relates to a machine for preparing a beverage from an ingredient, e.g. coffee or tea or cacao or chocolate. The beverage preparation machine can be an in-home or out of home machine. The machine may be for the preparation of coffee, tea, chocolate, cacao, milk, soup, baby food, etc. . . .

The beverage preparation typically includes the mixing of a plurality of beverage ingredients, e.g. water and milk powder, and/or the infusion of a beverage ingredient, such as an infusion of ground coffee or tea with water. One or more of such ingredients may be supplied in loose and/or agglomerate powder form and/or in liquid form, in particular in a concentrate form. A carrier or diluents liquid, e.g. water, may be mixed with such ingredient to form the beverage. Typically, a predetermined amount of beverage is formed and dispensed on user-request, which corresponds to a portion (e.g. a serving). The volume of such a serving may be in the range of 15 to 1000 ml such as 25 to 600 ml for instance 40 to 250 ml, e.g. the volume for filling a cup or mug, depending on the type of beverage. Formed and dispensed beverages may be selected from ristrettos, espressos, lungos, cappuccinos, café latte, americano coffees, teas, etc. . . . For example, a coffee machine may be configured for dispensing espressos, e.g. an adjustable volume of 20 to 60 ml per serving, and/or for dispensing lungos, e.g. a volume in the range of 70 to 200 ml per serving, and/or for dispensing americanos, e.g. a volume in the range of 150 to 750 ml.

The ingredient may be supplied into and processed in such machine within in a capsule, e.g. provided with a flange. Such capsule may be of the type described above under the title “Field of the Invention” and/or the capsule may include an ingredient described under the same title. Examples of suitable capsules are in disclosed WO 2008/148601, WO 2008/148604, WO 2008/148646, WO 2008/148650, WO 2008/148656, WO 2008/148834, WO 2011/141532, WO 2011/141535, WO 2013/072239, WO 2013/072297, WO 2013/072326, WO 2015/044400. The capsule may be of the variety commercialised by Nespresso under the brand Vertuo.

The capsule can comprise a capsule body. The capsule body may be symmetric or asymmetric, conical or frusto-conical, frusto-pyramidal, cylindrical or prismatic, pyramidal or spherical or hemispherical or frusto-spherical, domical or frusto-domical. The capsule body may contain the ingredient, e.g. ground coffee, tea or cacao or another beverage ingredient.

The capsule can have a circular peripheral annulus flange, e.g. a flexible or rigid flange, extending from a peripheral part, e.g. an edge or face, of the capsule body.

The machine has a body including a fluid line that extends from a source of liquid to a beverage outlet. The latter is located at or on a body front face delimiting a front area for locating a beverage collection user-recipient, such as a cup or a mug.

The front area can be delimited by a support for supporting the user-recipient under the beverage outlet. The support may be disconnectably connected e.g. via a connection arrangement, e.g. a hook member and one more hook receivers, for allowing a placement of user-recipients of different heights under the beverage outlet.

Examples of such user-recipient supports are disclosed in EP 0 549 887, EP 1 440 639, EP 1 731 065, EP 1 867 260, U.S. Pat. Nos. 5,161,455, 5,353,692, WO 2009/074557, WO 2009/074559, WO 2009/135869, WO 2011/154492, WO 2012/007313, WO 2013/186339, WO 2016/096705, WO 2016/096706, WO 2016/096707 and WO 2020/030740. A suitable support has been commercialised by Nespresso in a coffee maker branded Vertuo Next.

The machine has a first module that is assemblable to the body and that is disassemblable therefrom by the user, e.g. frequently disassemblable and assemblable by the user. For instance, the first module forming the source of liquid, such as a water tank. Examples of water tanks are also known from the coffee maker Vertuo Next or from WO 2011/083103, WO 2011/089210 and WO 2017/081055.

The machine includes a second module different to the first module. The second module is assemblable to the body and is disassemblable therefrom by the e.g. frequently user, disassemblable and assemblable by the user. For instance, the second module forms a reservoir of ingredient and/or waste. Examples of such reservoirs are also known from the coffee maker Vertuo Next or from WO2009/074559.

Generally speaking, at least one of the first and second modules may form the source of liquid.

The body further has a side face that is different to the front face.

The side face has a first assembly arrangement for assembly by the user of the first module to the body and a second assembly arrangement for assembly by the user of the second module to the body.

Such a configuration can be advantageous for the user to position the machine in a dedicated place e.g. in narrow environments, for instance in a corner. Indeed, by providing that the first and second modules are accessible form the same side face of the machine's body, the opposite side face and the rear face (when present) of the machine's body can be placed against or close to walls, and typically left inaccessible to the user. Hence, the user may be able to access the first and second modules, e.g. for frequent emptying, cleaning, refilling or other frequent servicing, without having to displace the machine even when such machine is placed in a corner.

The machine may include one or more further modules for assembly and disassembly by the user to the body's side face in the manner of assembly/disassembly of the first and second modules described above, typically involving corresponding further assembly arrangements.

The side face and the first and/or second assembly arrangement(s) may be so configured that the first and/or second module(s) is/are assemblable to the assembly arrangement from outside the body adjacent the side face.

The first and/or second module(s) can be assemblable outside the body.

The first and/or second module(s) may be assemblable inside the body.

The front face may extend along a horizontal front average direction and the side face may extend along a horizontal side average direction, the horizontal front average direction and the horizontal side average direction being at an angle relative to one another in the range of 45° to 135°, such as 60° to 120°, for instance 75° to 105°, for example 85° to 95°, e.g. about 90°.

The body may include a rear face substantially opposite the front face, such as a rear face free of any module (frequently) assemblable to the body and that is (frequently) disassemblable therefrom by the user, e.g. free of any module that has a liquid and/or an ingredient reservoir.

The body can have a companion face substantially opposite the side face, such as a companion face free of any module that is (frequently) assemblable to the body and that is (frequently) disassemblable therefrom by the user, e.g. free of any module that has a liquid and/or an ingredient reservoir.

The body may have a bottom face forming a machine foot when such machine is in operation for preparing said beverage. Such foot may be placed onto a support surface such as a table top or shelf surface or cabinet top.

Typically, the body also has a top face, for instance bearing a user-interface such as one or more buttons and/or visual feedback devices.

At least one of the rear face, companion face, bottom face and top face, may be associated with an electric cord that does not require frequent access by the user. The cord may be fixed to the body or separable therefrom by a plug-and-socket connection.

Such electric cord or other potentially user-removable part of the machine, in so far as it is not required to be frequently disassembled from the body by the user it is not considered to involve the abovementioned issue linked to a module is to the that frequently assembled body and disassembled from the body by the user.

One of the first and second modules can be assembled at the side face remotely from the front face, e.g. at or close to a or the abovementioned rear face. The other of the first and second modules can be assembled at the side face between the front face and said one of the first and second modules. Such other module can for instance be assembled at about half way between the front face and such rear face.

The front face and the side face may delimit a free area external to such machine for displacing at least one of the first and second modules from the front face along the side face outside the body to its assembly arrangement.

The first assembly arrangement can be so configured that the first module is assembled to the body on the side face outside the body, e.g. in front of the side face. For instance, the first assembly arrangement includes a connector, e.g. an arm, projecting out of the body for assembling the first module thereto.

The second assembly arrangement may be so configured that the second module is assembled to the body through the side face. For instance, the second assembly arrangement comprising a passage in the side face for passing the second module from outside the body to a module seat located in the body.

The first module may form the source of liquid and may be configured to store the abovementioned liquid, e.g. water, the first module being disconnectably connected to the fluid line such that the liquid can be supplied from the first module into the fluid line, e.g. a liquid intended to be processed in the body to prepare the beverage. For instance, the first module forming a water tank e.g. fitted with a removable lid.

The second module may be configured to store the abovementioned ingredient, e.g. a used flavouring ingredient, when assembled to the second assembly arrangement the second module being in communication with an ingredient processing unit in the body for allowing a passage of the ingredient between the ingredient processing unit and the module, e.g. for allowing a passage of the used flavouring ingredient from the ingredient processing unit into the second module. For instance, the second module has an upper opening configured to receive the ingredient and optionally an upper cavity for storing solids and a lower cavity for storing liquids.

The body may include a or the abovementioned ingredient processing unit has seat that for receiving the a abovementioned ingredient and in which the ingredient is processed to form the beverage. For instance, the body has an actuator, e.g. a motor, for driving the seat in rotation and centrifuging the ingredient in the seat to form the beverage. The seat may delimit a cavity for receiving at least part of the ingredient, for contained instance in the abovementioned capsule. The seat may cooperate with a closure member e.g. provided with a liquid inlet passage into the cavity and/or a beverage outlet passage out of the cavity. The seat and the closure member can be moveable one relative to the other between a closed position for processing the ingredient in the seat and an open position for introducing the ingredient into the seat and/or removing the ingredient from the seat. For instance, the seat and the closure member are movable in translation and/or in rotation about a pivoting axis. Examples of such seats and closure members are for instance disclosed in WO2014/096122, WO2014/096123 and WO2020/201469.

The seat may be associated with a transfer arrangement configured to transfer the ingredient into and/or out of the seat. Examples of suitable transfer arrangements are disclosed in WO2012041605, WO 2017/046294 and WO 2017/202746.

The transfer arrangement may be configured to remove the ingredient from the seat and direct the ingredient towards at least one of the first and second modules, e.g. towards the second module, for example by gravity.

The transfer arrangement can have at least one of: a pusher configured to push the ingredient, e.g. contained in the capsule; and a grip configured to grip the ingredient, e.g. at the capsule flange when the ingredient is contained in the abovementioned capsule, the grip including for instance a slide configured to allow a sliding of the capsule along the slide. The pusher and/or the grip may be configured to transfer the ingredient into and/or out of the seat.

The fluid line may include a liquid driver, such as a pump, for driving the liquid from the source of liquid towards the outlet. Examples of pumps and their incorporation into beverage machines are disclosed in WO 2009/150030, WO 2010/108700, WO 2011/107574 and WO 2013/098173.

The fluid line can incorporate a thermal conditioner, such as a heater and/or a cooler, for thermally conditioning the liquid from the source of liquid. The thermal conditioner may be a boiler or a thermoblock or an on demand heater (ODH), for instance an ODH type disclosed in EP 1 253 844, EP 1 380 243 and EP 1 809 151. Further examples of suitable thermal conditioners can be found in WO 2010/089329, WO 2014/090850 and WO 2020/201469.

The fluid line may have one or more liquid guides, such as tubes and/or pipes, for guiding the liquid between the source of liquid and the outlet.

With this invention all the assemblable/disassemblable modules, in particular the first and second modules, that need frequently to be assembled/diassembled by the user can be located on the side face and optionally on the front face and/or on the top face.

“Frequently” assembled and diassembled means that the assembly/disassembly of the module needs to be performed by the user at least once every 30 beverage servings (e.g. beverage preparation cycles), for instance at least once every 20 servings, typically at least once every 15 servings, e.g. at least once every 10 servings. Modules that need to be accessed only infrequently, e.g. less than once every few hundreds or thousands of servings, for instance for set-up or descaling or replacement of machine components, may also be located on these side face, front face and top face. However, such infrequently user-accessed modules may also be located elsewhere on the machine, especially since their occasional access does not interfere with the everyday normal use of the machine.

### BRIEF DESCRIPTION OF THE DRAWINGS

The invention will now be described with reference to the schematic drawings, wherein:

FIG. 1 is a front view of a machine according to the invention;

FIG. 2 is a view from above of the machine shown in FIG. 1; and

FIG. 3 is a cross-sectional side view of the machine shown in FIG. 1.

### DETAILED DESCRIPTION

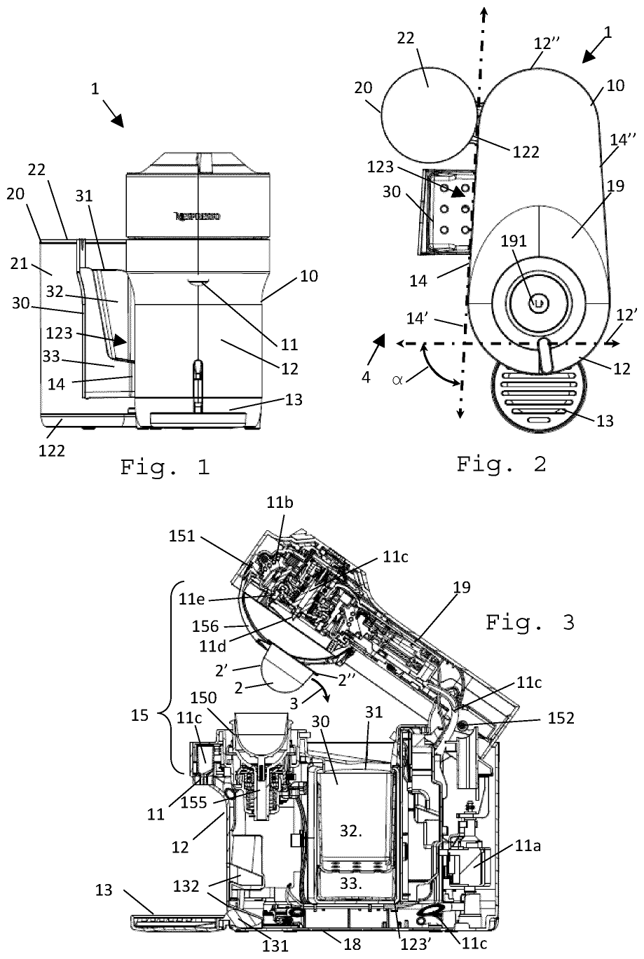

FIGS. 1 to 3 illustrate an exemplary embodiment of a beverage machine 1 in accordance with the invention.

As illustrated in FIGS. 3, the ingredient may be supplied in the form of an ingredient capsule 2′, e.g. of the type described above under the header “Field of the Invention”.

Machine 1 is configured for preparing a beverage from an ingredient 2, e.g. coffee or tea or cacao or chocolate.

Ingredient 2 may be supplied into and processed in machine 1 within in a capsule 2′ e.g. provided with a flange 2″.

Machine 1 has a body 10 comprising a fluid line 11, 11a, 11b, 11c, 11d, 11e extending from a source of liquid to a beverage outlet 11 located at or on a body front face 12 that delimits a front area for locating a beverage collection user-recipient, such as a cup or a mug.

For instance, the front area is delimited by a support 13 for supporting the user-recipient under beverage outlet 11. Support 13 can be disconnectably connected e.g. via a connection arrangement 131, 132, e.g. a hook member 131 and one more hook receivers 132, for allowing a placement of user-recipients of different heights under the beverage outlet 11.

Machine 1 has a first module 20 that is assemblable to body and that is disassemblable therefrom by the user, such as frequently disassemblable and assemblable by the user. For instance, first module 20 forms the source of liquid.

Second module 30 is different to first module 20. Second module 30 is assemblable to body 10 and disassemblable therefrom by the user, such as frequently disassemblable and assemblable by the user. For instance, second module 30 forms a reservoir of ingredient 2 and/or waste.

Body 10 further comprises a side face 14 that is different to front face 12. For instance, at least one of first and second modules 20, 30 form the source of liquid.

Side face 14 has a first assembly arrangement 122 for assembly by said user of the first module 20 to body 10 and a second assembly arrangement 123 for assembly by user of the second module 30 to body 10.

Side face 14 and first and/or second assembly arrangement(s) 122, 123 can be so configured that first and/or second module(s) 20,30 is/are assemblable to the assembly arrangement from outside body 10 adjacent side face 14.

First and/or second module(s) 20 may be assemblable outside body 10.

First and/or second module(s) 30 can be assemblable inside body 10.

Front face 12 may extend along a horizontal front average direction 12′ and side face 14 may extend along a horizontal side average direction 14′, horizontal front average direction 12′ and horizontal side average direction 14′ being at an angle α relative to one another in the range of 45° to 135°, such as 60° to 120°, for instance 75° to 105°, for example 85° to 95°, e.g. about 90°.

Body 10 can have a rear face 12″ substantially opposite front face 12, such as a rear face 12″ free of any module that is assemblable to the body 10 and that is disassemblable therefrom by the user, e.g. free of any module that has a liquid and/or an ingredient reservoir.

Body 10 may include a companion face 14″ substantially opposite side face 14, such as a companion face 14″ free of any module that is assemblable to body 10 and that is disassemblable therefrom by the user, e.g. free of any module that has a liquid and/or an ingredient reservoir.

Body 10 can have a bottom face 18 forming a machine foot when such machine 1 is in operation for preparing the beverage.

Body 10 may include a top face 19, e.g. bearing a user-interface such as one or more buttons and/or visual feedback devices 191.

One module 20 of first and second modules 20,30 can be assemblable at side face 14 remotely from front face 12, e.g. at or close to rear face 12″. The other module 30 of first and second modules 20,30 can be assemblable at side face 14 between front face 12 and such one module 20 e.g. assemblable at about half way between front face 12 and rear face 12″.

Front face 12 and side face 14 may delimit a free area 4 external to such machine 1 for displacing at least one of first and second modules 20, 30 from front face 12 along side face 14 outside the body 10 to its assembly arrangement 122,123.

First assembly arrangement 122 may be so configured that first module 20 is assembled to body 10 on side face 14 outside body 10, e.g. in front of side face 14. For instance the first assembly arrangement 122 has a connector, e.g. an arm, projecting out of body 10 for assembling first module 20 thereto.

Second assembly arrangement 123 is so configured that second module 30 is assembled to body 10 through side face 14. For instance, second arrangement 123 includes a passage in side face 14 for passing second module 30 from outside body 10 to a module seat 123′ located in body 10.

First module 20 may form the source of liquid and may be configured to store the liquid, e.g. water. First module 20 can be disconnectably connected to fluid line 11, 11a, 11b, 11c, 11d, 11e such that the liquid can be supplied from first module 20 into fluid line 11, 11a, 11b, 11c, 11d, 11e. The liquid may be intended to be processed in body 10 to prepare the beverage. For instance, first module 20 has a water tank 21 e.g. fitted with a removable lid 22.

Second module 30 can be configured to store ingredient 2, e.g. a used flavouring ingredient 2, and when assembled to second assembly arrangement 123 second module 30 can be in communication with an ingredient processing unit 15 in body 10 for allowing a passage of ingredient 2 between ingredient processing unit 15 and module 30, e.g. for allowing a passage of used flavouring ingredient 2 from ingredient processing unit 15 into second module 30. For instance second module 30 has an upper opening 31 configured to receive ingredient 2 and optionally an upper cavity 32 for storing solids and a lower cavity 33 for storing liquids.

Body 10 may include a or the above ingredient processing unit 15 that has a seat 150 for receiving ingredient 2 and in which ingredient 2 is processed to form the beverage. Body 10 may comprise an actuator for driving seat 150 in rotation and centrifuging ingredient 2 in seat 150 to form the beverage.

Seat 150 can delimit a cavity for receiving at least part of ingredient 2, for instance contained in capsule 2′, and can cooperate with a closure member 151 e.g. provided with a liquid inlet passage 11d into the cavity and/or a beverage outlet passage 11e out of the cavity. Seat 150 and closure member 151 may be moveable one relative to the other between a closed position for processing ingredient 2 in seat 150 and an open position for introducing ingredient 2 into seat 150 and/or removing ingredient 2 from seat 150. For instance, seat 150 and closure member 151 are movable in translation and/or in rotation about a pivoting axis 152.

Seat 150 may be associated with a transfer arrangement 155,156 configured to transfer ingredient 2 into and/or out of seat 150.

Transfer arrangement 155, 156 can be configured to remove ingredient 2 from seat 150 and direct ingredient 2 towards at least one of first and second modules 20, 30, e.g. towards second module 30, optionally by gravity 3.

Transfer arrangement 155, 156 may have a pusher 155 configured to push ingredient 2, e.g. contained in capsule 2′.

Transfer arrangement 155, 156 can have a grip 156 configured to grip ingredient 2, e.g. at capsule flange 2″ when ingredient 2 is contained in capsule 2′. Grip 156 may include a slide configured to allow a sliding of capsule 2′ along the slide.

Pusher 155 and/or grip 156 may be configured to transfer ingredient 2 into and/or out of seat 150.

Fluid line 11, 11a, 11b, 11c, 11d, 11e may have at least one of:
a liquid driver 11a, such as a pump, for driving the liquid from the source of liquid towards outlet 11;
a thermal conditioner 11b, such as a heater and/or a cooler, for thermally conditioning the liquid from the source of liquid; and
one or more liquid guides 11c, such as tubes and/or pipes, for guiding the liquid between the source of liquid and outlet 11.

1. A machine (1) for preparing a beverage from an ingredient, the machine comprising:
a body comprising a fluid line extending from a source of liquid to a beverage outlet located at or on a body front face defining a front area for locating a beverage collection user-recipient;
a first module that is assemblable to the body and that is disassemblable therefrom by said user; and
a second module different to the first module, the second module being assemblable to the body and being disassemblable therefrom by said user,
the body further comprising a side face that is different to the front face,
the side face has: a first assembly arrangement for assembly by said user of the first module to the body; and a second assembly arrangement for assembly by said user of the second module to the body.

2. The machine of claim 1, wherein the side face and the first and/or second assembly arrangement(s) are so configured that the first and/or second module(s) is/are assemblable to the assembly arrangement from outside the body adjacent the side face.

3. The machine of claim 1, wherein the front face extends along a horizontal front average direction and the side face extends along a horizontal side average direction, the horizontal front average direction and the horizontal side average direction being at an angle (α) relative to one another in the range of 45° to 135°.

4. The machine of claim 1, wherein the body comprises at least one of:
a rear face substantially opposite the front face;
a companion face substantially opposite the side face;
a bottom face forming a machine foot when such machine is in operation for preparing said beverage; and
a top face.

5. The machine of claim 1, wherein one module of said first and second modules is assemblable at the side face remotely from the front face and wherein the other module of said first and second modules is assemblable at the side face between the front face and said one module e.g. assemblable at about half way between the front face and a or said rear face.

6. The machine of claim 1, wherein the front face and the side face define a free area external to such machine for displacing at least one of the first and second modules from the front face along the side face outside the body to its assembly arrangement.

7. The machine of claim 1, wherein the first assembly arrangement is so configured that the first module is assembled to the body on the side face outside the body.

8. The machine of claim 1, wherein the second assembly arrangement is so configured that the second module is assembled to the body through the side face.

9. The machine of claim 1, wherein the first module forms said source of liquid and is configured to store said liquid, the first module being disconnectably connected to the fluid line such that said liquid can be supplied from the first module into the fluid line.

10. The machine of claim 1, wherein the second module is configured to store said ingredient and when assembled to the second assembly arrangement the second module is in communication with an ingredient processing unit in the body for allowing a passage of said ingredient between the ingredient processing unit and the module.

11. The machine of claim 1, wherein the body comprises a seat for receiving said ingredient and in which said ingredient is processed to form said beverage.

12. The machine of claim 11, wherein the seat defines a cavity for receiving at least part of said ingredient and cooperates with a closure member, the seat and the closure member being moveable one relative to the other between a closed position for processing said ingredient in the seat and an open position for introducing said ingredient into the seat and/or removing said ingredient from the seat, for instance the seat and the closure member being movable in translation and/or in rotation about a pivoting axis.

13. The machine of claim 11, wherein the seat is associated with a transfer arrangement configured to transfer said ingredient into and/or out of the seat.

14. The machine of claim 13, wherein the transfer arrangement has at least one of:
a pusher configured to push said ingredient; and
a grip configured to grip said ingredient when said ingredient is contained in said capsule,
configured to transfer said ingredient into and/or out of the seat.

15. The machine of claim 1, wherein the fluid line comprises at least one of:
a liquid driver for driving said liquid from the source of liquid towards the outlet;
a thermal conditioner, such as a heater and/or a cooler, for thermally conditioning said liquid from the source of liquid; and
one or more liquid guides for guiding said liquid between the source of liquid and the outlet.
